(19) United States
(12) Patent Application Publication
(10) Pub. No.: US 2014/0360254 A1
(43) Pub. Date: Dec. 11, 2014

(54) CAMSHAFT POSITION PULSE-GENERATING WHEEL AND METHOD AND DEVICE FOR ASCERTAINING A CAMSHAFT POSITION

(71) Applicants: Carsten Deringer, Aichwald (DE); Paul Stuckert, Waiblingen (DE); Ralf Drescher, Kornal-Muenchingen (DE); Ulrich-Michael Nefzer, Weinstadt (DE)

(72) Inventors: Carsten Deringer, Aichwald (DE); Paul Stuckert, Waiblingen (DE); Ralf Drescher, Kornal-Muenchingen (DE); Ulrich-Michael Nefzer, Weinstadt (DE)

(73) Assignee: Robert Bosch GmbH, Stuttgart (DE)

(21) Appl. No.: 14/299,335

(22) Filed: Jun. 9, 2014

(30) Foreign Application Priority Data
Jun. 11, 2013 (DE) 10 2013 210 838.9

(51) Int. Cl. G01M 15/06

(52) U.S. Cl. CPC G01M 15/06
USPC 73/114.26

(57) ABSTRACT

A camshaft position pulse-generating wheel having a plurality of teeth on its circumference at irregular angular distances and one tooth edge in each case, at least at 0°, 90°, 120°, 180°, 240° and 270° of its circumference, and a device for ascertaining a camshaft position. In this position, the camshaft position pulse-generating wheel is connected, in a torsionally fixed manner, to a camshaft of a four-stroke internal combustion engine having at least one cylinder and a camshaft position sensor to detect a position of a tooth edge of the camshaft position pulse-generating wheel. For determining the camshaft position, per revolution of the camshaft and per cylinder of the internal combustion engine, either exclusively a camshaft position is assigned to a position of a negative tooth edge of the camshaft position pulse-generating wheel or to a position of a positive or a negative tooth edge of the camshaft position pulse-generating wheel.

### RELATED APPLICATION INFORMATION

The present application claims priority to and the benefit of German patent application no. 10 2013 210 838.9, which was filed in Germany on Jun. 11, 2013, the disclosure of which is incorporated herein by reference.

### FIELD OF THE INVENTION

The present invention relates to a camshaft position pulse-generating wheel. Furthermore, the present invention relates to a device for ascertaining a camshaft position, which includes the camshaft position pulse-generating wheel. In addition, the present invention relates to two methods for determining a camshaft position using the device according to the present invention. Moreover, the present invention relates to a computer program which carries out all the steps of the method according to the present invention, when it is run on a computer. Finally, the present invention relates to a computer program product having program code, which is stored on a machine-readable carrier for implementing the method when the program is executed on a computer or a control unit.

### BACKGROUND INFORMATION

Internal combustion engines, whose injection control is not mechanically coupled to the engine position, in addition to the crank-angle sensor on the crankshaft, require a phase sensor on the camshafts, using which it may be sensed which of the cylinders of the engine, which next reach the top dead center (TDC), are currently in a power stroke. In addition, in engines having camshaft phasing, the current positions of the camshafts are ascertained via a comparison of the positions of equidistant tooth edges of teeth on the circumference of camshaft position pulse-generating wheels with reference to the crankshaft. In the case of current pulse-generating wheels, at present, such as are used in Diesel and Otto engines capable of quick starts, four of these tooth edges are available per camshaft revolution. Consequently, in a 4-cylinder engine, one camshaft position information is available per cylinder. In engines having 3, 6 or 8 cylinders, the camshaft position information is not, however, equally distributed, which has negative effects on the accuracy of the calculated camshaft position, and, as a result, on the filling of the cylinder and the exhaust gases of the internal combustion engine. Other, so-called Z+1 camshaft position pulse-generating wheels use one tooth per cylinder and one additional tooth for the transmittal of the phase information. Thus, these pulse-generating wheels specially have to be adjusted to the engine in which they are to be used, with respect to their number of teeth.

### SUMMARY OF THE INVENTION

The camshaft position pulse-generating wheel, according to the present invention, which has a plurality of teeth on its circumference at irregular angular spacing has one tooth edge in each case, at least at 0°, 90°, 120°, 180°, 240° and 270° of its circumference.

Ideally, for each cylinder of an internal combustion engine, the position of the camshaft is determined at least once per camshaft revolution. This is possible for four-stroke internal combustion engines having 1, 2, 3 or 4 cylinders, using the camshaft position pulse-generating wheel according to the present invention. The camshaft position pulse-generating wheel also may have one tooth edge in each case at 60° and at 300° of its circumference. This makes possible a position determination of the camshaft per camshaft revolution for each cylinder, even for internal combustion engines having 6 cylinders. Particularly, the camshaft position pulse-generating wheel may have one tooth edge in each case, even at 45°, 135°, 225° and 315° of its circumference. This also makes it possible for an internal combustion engine having 8 cylinders to determine the position of the camshaft for each cylinder once per camshaft revolution.

To ascertain the position of the camshaft, the device according to the present invention is provided, which includes the camshaft position pulse-generating wheel according to the present invention. This is connected to a camshaft of a 4-stroke internal combustion engine having at least one cylinder in a torsionally fixed manner. A camshaft position sensor is prepared to detect the position of a tooth edge of the camshaft position pulse-generating wheel. In one specific embodiment of the present invention, the camshaft position sensor is prepared to detect exclusively a position of a negative tooth edge of the camshaft position pulse-generating wheel. In this case, the camshaft position pulse-generating wheel is used as a pulse-generating wheel. In another specific embodiment of the device according to the present invention, the camshaft position sensor is prepared to detect a position of a positive and a negative tooth edge of the camshaft position pulse-generating wheel. In this specific embodiment, the camshaft position pulse-generating wheel is used as a segment pulse generator wheel.

When the camshaft position pulse-generating wheel is used as a pulse-generating wheel, in a method for determining the position of the camshaft, per revolution of the camshaft and per cylinder of the internal combustion engine, a camshaft position is assigned to a negative tooth edge of the camshaft position pulse-generating wheel. In order to enable a phase coding using the camshaft position pulse-generating wheel, additional negative tooth edges of the camshaft position pulse-generating wheel may each have assigned to them a camshaft phase. For this purpose, the camshaft position pulse-generating wheel, besides the tooth edges which make possible its usability for position determination of a camshaft in a 1-cylinder, a 2-cylinder, a 3-cylinder or a 4-cylinder engine, and possibly also in a 6-cylinder or an 8-cylinder engine, may have additional negative tooth edges.

When the camshaft position pulse-generating wheel is used as a segment pulse-generating wheel, in a method for determining the position of the camshaft, per revolution of the camshaft and per cylinder of the internal combustion engine, a camshaft position is assigned to a positive or a negative tooth edge of the camshaft position pulse-generating wheel. In order to enable a phase coding using the camshaft position pulse-generating wheel, in this case a camshaft phase may be assigned to at least one distance between a positive and a negative tooth edge of the camshaft position pulse-generating wheel.

By a negative tooth edge one may understand, according to the present invention, an edge of a tooth on the circumference of the camshaft position pulse-generating wheel, at which, in the rotational direction of the camshaft position pulse-generating wheel, a transition takes from a higher level to a lower level. As a positive tooth edge, an edge of a tooth is designated at which, in the rotational direction of the camshaft position pulse-generating wheel, a transition takes from a lower level to an higher level. The tooth edges, to which a camshaft position or a camshaft phase is assigned in the method according to the present invention, may be designated as active tooth edges.

The computer program according to the present invention executes all the steps of the method according to the present invention when it is run on a computer or a control unit. In order to make possible an implementation of the method according to the present invention in a control unit that is already present, without having to make structural changes on it, the computer program product, according to the present invention, is provided with program code which is stored on a machine-readable carrier and is used for carrying out the method, according to the present invention, when the program is executed on a computer or a control unit.

Exemplary embodiments of the present invention are illustrated schematically in the drawings and are explained in greater detail in the following description.

### BRIEF DESCRIPTION OF THE DRAWINGS

FIG. 1 shows a device for ascertaining a position of a camshaft according to one specific embodiment of the present invention.

FIG. 2 shows an assignment of camshaft angles and crank angles to tooth edges of a camshaft position pulse-generating wheel in a method according to one specific embodiment of the present invention.

FIG. 3 shows schematically the positioning of teeth on the circumference of a camshaft position pulse-generating wheel in several specific embodiments of the present invention.

### DETAILED DESCRIPTION

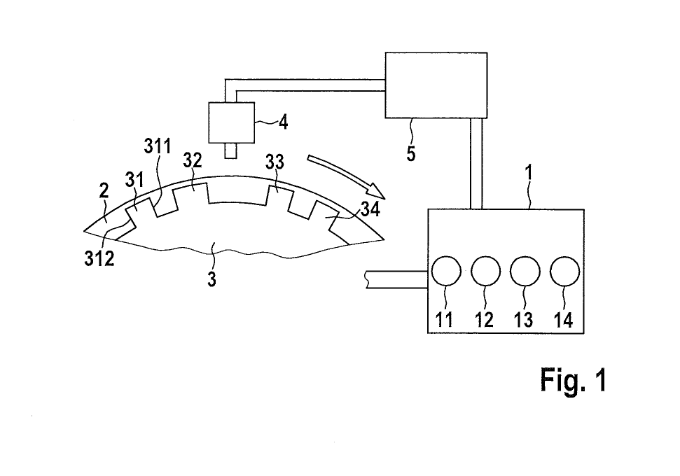

FIG. 1 shows schematically a section of a device for ascertaining a position of a camshaft according to one specific embodiment of the present invention. An internal combustion engine 1, which is configured as an in-line engine, has four cylinders 11, 12, 13, 14. Two adjustable camshafts 2 are assigned to the cylinders 11, 12, 13, 14. On each of these camshafts 2, a camshaft position pulse-generating wheel 3 is situated, which is connected to camshaft 2 in a torsionally fixed manner. It has on its circumference a plurality of teeth 31, 32, 33, 34 at irregular angular distances. Each of the teeth 31, 32, 33, 34 has a positive tooth edge 311 and a negative tooth edge 312. A camshaft position sensor 4 is prepared to detect the position of a tooth edge 311, 312 of camshaft position pulse-generating wheel 3. Camshaft position pulse-generating wheel 4 passes the detected information on to a control unit 5.

In order to be able to determine for each cylinder 11, 12, 13, 14 of internal combustion engine 1, at least once, the position of camshaft 2 per camshaft revolution, the following requirements come about for internal combustion engines 1 having a different number of cylinders:

A 1-cylinder engine requires a camshaft position information at least once per camshaft revolution, that is, every 720° crankshaft.

A 2-cylinder engine requires a camshaft position information at least twice per camshaft revolution, that is, every 360° crankshaft.

A 3-cylinder engine requires a camshaft position information, at least three times per camshaft revolution, that is, every 240° crankshaft.

A 4-cylinder engine requires a camshaft position information at least four times per camshaft revolution, that is, every 180° crankshaft.

A 6-cylinder engine requires a camshaft position information at least six times per camshaft revolution, that is, every 120° crankshaft.

An 8-cylinder engine requires a camshaft position information at least eight times per camshaft revolution, that is, every 90° crankshaft.

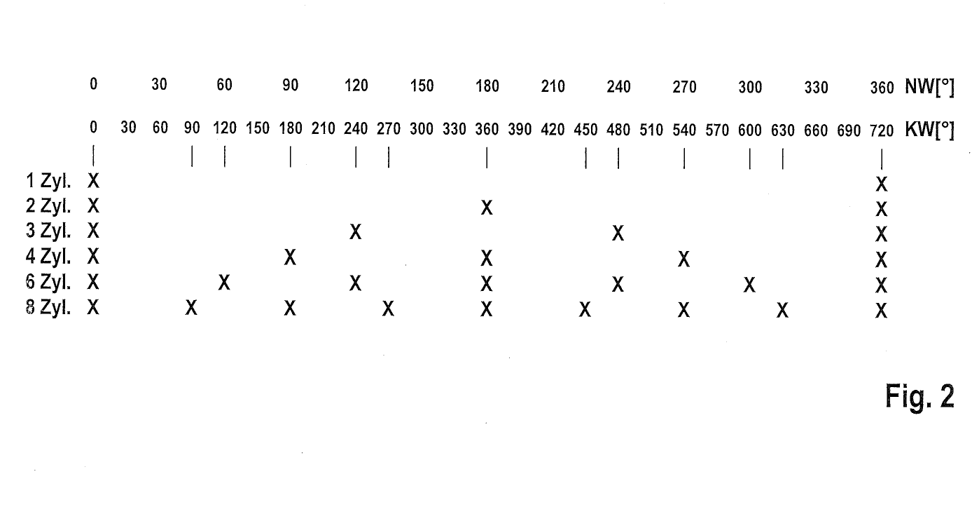

FIG. 2 shows which tooth edge positions camshaft position pulse-generating wheel 3 has to have to be able to be used for internal combustion engines 1 having 1 cylinder, 2 cylinders, 3 cylinders, 4 cylinders, 6 cylinders and 8 cylinders. In a 4-stroke internal combustion engine 1, since camshaft 2 completes one revolution per two revolutions of the crankshaft (not shown), 360° camshaft angle NW in the illustration correspond to 720° crank angle KW.

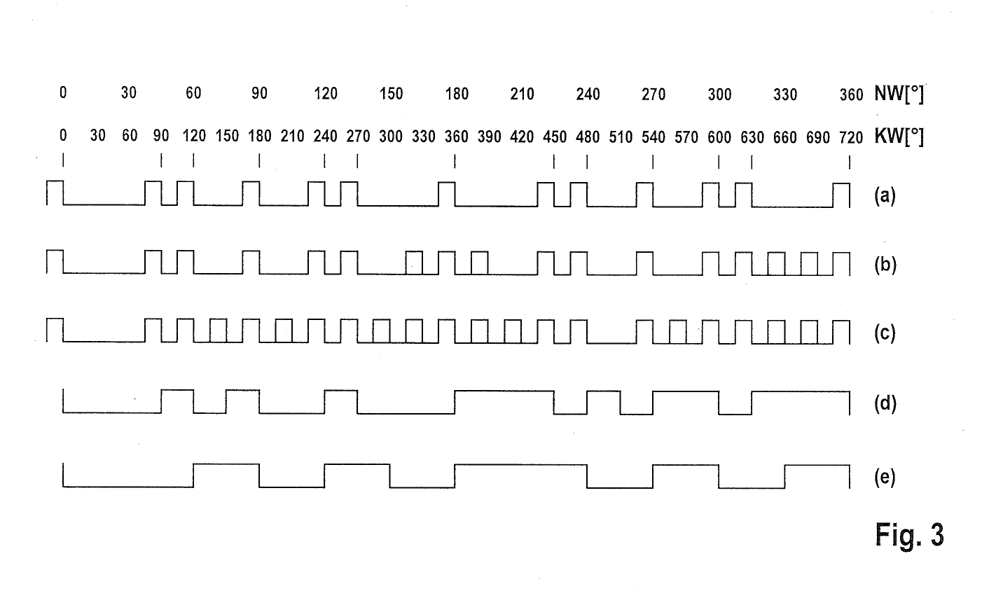

FIG. 3 schematically shows the edge distribution for camshaft position pulse-generating wheels according to different specific embodiments of the present invention.

Camshaft position pulse-generating wheels (a) through (c) may be used, in this context, for internal combustion engines 1 having all the numbers of cylinders, mentioned above, as pulse-generating wheels. Camshaft position pulse-generating wheel (a) functions as a base pulse-generating wheel without phase coding, in this instance. Per revolution of camshaft 2 and per cylinder of internal combustion engine 1, a camshaft position is assigned, in this case, to a position of a negative tooth edge of camshaft position pulse-generating wheel 3. If phase coding is also to be achieved via camshaft position pulse-generating wheel 3 as a pulse-generating wheel, additional negative tooth edges of the camshaft position pulse-generating wheel may be provided in specific embodiments (b) and (c), to each of which a camshaft phase is assigned. In specific embodiment (b), there takes place, in this case, a phase coding using additional tooth edges in long segments between the tooth edges of specific embodiment (a). In specific embodiment (c) a phase coding takes place by an arrangement of tooth edges, which cause asymmetrical pulse pauses in the sensor signal of camshaft position sensor 4.

Specific embodiment (d) shows a tooth edge distribution for a segment pulse-generating wheel having phase coding by level and segment length, which is able to be used for internal combustion engines 1 having all the numbers of cylinders mentioned above. For the determination of the position of the camshaft, per revolution of camshaft 2 and per cylinder of internal combustion engine 1, a camshaft position is assigned to a position of a positive or a negative tooth edge of camshaft position pulse-generating wheel 3. For the phase coding, a camshaft shaft phase is assigned for the phase coding, at least at a distance between a positive and a negative tooth edge of the camshaft position pulse-generating wheel.

Specific embodiment (e) shows a simplified version of the tooth edge distribution of the segment pulse-generating wheel according to specific embodiment (d), which has fewer tooth edges, and is therewith suitable only for use in internal combustion engines 1 having 1, 2, 3, 4 or 6 cylinders, but not having 8 cylinders.

What is claimed is:

1. A camshaft position pulse-generating wheel, comprising:
a camshaft position pulse-generating wheel arrangement having a plurality of teeth on a circumference at irregular angular distances, wherein it has a tooth edge in each case, at least at 0°, 90°, 120°, 180°, 240° and 270° of the circumference.

2. The camshaft position pulse-generating wheel of claim 1, wherein there is a tooth edge in each case at 60° and at 300° of its circumference.

3. The camshaft position pulse-generating wheel of claim 2, wherein there is a tooth edge in each case at 45°, 135°, 225° and 315° of its circumference.

4. A device for ascertaining a position of a camshaft, comprising:
a camshaft position pulse-generating wheel having a plurality of teeth on a circumference at irregular angular distances, wherein it has a tooth edge in each case, at least at 0°, 90°, 120°, 180°, 240° and 270° of the circumference, which is connected to a camshaft of a four-stroke internal combustion engine having at least one cylinder in a torsionally fixed manner; and
a camshaft position sensor to detect a position of a tooth edge of the camshaft position pulse-generating wheel.

5. The device of claim 4, wherein the camshaft position sensor is configured to detect exclusively a position of a negative tooth edge of the camshaft position pulse-generating wheel.

6. The device of claim 4, wherein the camshaft position sensor is configured to detect a position of a positive and a negative tooth edge of the camshaft position pulse-generating wheel.

7. A method for determining a position of a camshaft using a device or ascertaining a position of a camshaft, the method comprising:
assigning, per revolution of the camshaft and per cylinder of the internal combustion engine, a camshaft position to a position of a negative tooth edge of a camshaft position pulse-generating wheel;
wherein the device for ascertaining a position of a camshaft, includes:
the camshaft position pulse-generating wheel having a plurality of teeth on a circumference at irregular angular distances, wherein it has a tooth edge in each case, at least at 0°, 90°, 120°, 180°, 240° and 270° of the circumference, which is connected to a camshaft of a four-stroke internal combustion engine having at least one cylinder in a torsionally fixed manner; and
a camshaft position sensor to detect a position of a tooth edge of the camshaft position pulse-generating wheel.

8. The method of claim 7, wherein a camshaft phase is assigned in each case to further negative tooth edges of the camshaft position pulse-generating wheel.

9. The method of claim 7, wherein the camshaft position sensor is configured to detect a position of a positive and a negative tooth edge of the camshaft position pulse-generating wheel.

10. The method of claim 9, wherein a camshaft phase is assigned to at least one distance between a positive and a negative tooth edge of the camshaft position pulse-generating wheel.

11. A computer readable medium having a computer program, which is executable by a processor, comprising:
a program code arrangement having program code for determining a position of a camshaft using a device or ascertaining a position of a camshaft, by performing the following:
assigning, per revolution of the camshaft and per cylinder of the internal combustion engine, a camshaft position to a position of a negative tooth edge of a camshaft position pulse-generating wheel;
wherein the device for ascertaining a position of a camshaft, includes:
the camshaft position pulse-generating wheel having a plurality of teeth on a circumference at irregular angular distances, wherein it has a tooth edge in each case, at least at 0°, 90°, 120°, 180°, 240° and 270° of the circumference, which is connected to a camshaft of a four-stroke internal combustion engine having at least one cylinder in a torsionally fixed manner; and
a camshaft position sensor to detect a position of a tooth edge of the camshaft position pulse-generating wheel.

12. The computer readable medium of claim 11, wherein there is a tooth edge in each case at 60° and at 300° of its circumference.

13. The computer readable medium of claim 12, wherein there is a tooth edge in each case at 45°, 135°, 225° and 315° of its circumference.
